(19) United States
(12) Patent Application Publication
(10) Pub. No.: US 2019/0191110 A1
(43) Pub. Date: Jun. 20, 2019

(54) APPARATUSES, SYSTEMS, AND METHODS FOR AN ENHANCED FIELD-OF-VIEW IMAGING SYSTEM

(71) Applicant: Facebook, Inc., Menlo Park, CA (US)

(72) Inventor: Douglas Michael Mayle, San Francisco, CA (US)

(21) Appl. No.: 15/845,217

(22) Filed: Dec. 18, 2017

(51) Int. Cl. H04N 5/341; H04N 5/232; G02B 5/30

(52) U.S. Cl. CPC H04N 5/3415; H04N 5/23296; G02B 5/3025; H04N 5/23238

(57) ABSTRACT

The disclosed imaging device may include an image sensor with an imaging area that receives light to generate an image from the received light and an optics system that produces an image circle over the image sensor. The image circle may exceed at least one dimension of the imaging area of the image sensor. The imaging device may also include a positioning system coupled to the image sensor to move, e.g., pan or tilt, the image sensor with respect to the optics system, such that the image sensor may capture a portion of the image circle that exceeds the at least one dimension of the imaging area. Associated systems and methods are also disclosed.

### BACKGROUND

Imaging systems are used in a wide variety of applications to capture images, video, and other information characterizing a scene or objects within the scene. Imaging systems can utilize a wide variety of lenses that have unique optical characteristics, such as wide-angle lenses, that will allow more of the scene to be captured without having to move the camera far away from the scene. Ultra-wide-angle lenses, like fisheye lenses, can create panoramic or hemispherical images. At the same time, imaging systems have generally utilized rectangular film or image sensors to capture information through such lenses. The mismatch between rectangular photosensitive areas and the image circle produced by such lenses imposes certain trade-offs. Accordingly, such wide-angle imaging systems have not been entirely satisfactory.

### SUMMARY

As will be described in greater detail below, the instant disclosure describes imaging systems that may overcome or that may mitigate the problem of mismatch between rectangular image sensors and the image circle generated by wide angle lenses, such as fisheye lenses. Such imaging systems may include an imaging device. An exemplary imaging device may include an image sensor with an imaging area that receives light to generate an image from the received light. The imaging device may also include an optics system that produces an image circle over the image sensor from light received from a scene. The image circle may exceed at least one dimension of the imaging area of the image sensor. The imaging device may also include a positioning system coupled to the image sensor to move, e.g., pan or tilt, the image sensor with respect to the optics system, such that the image sensor may capture a portion of the image circle that exceeds the at least one dimension of the imaging area.

In some implementations, the optics system may include a fisheye lens. The imaging area may include an array of imaging subsensors. Each imaging subsensor of the array of imaging subsensors may be coupled to a positioning component included in the positioning system. Each individual positioning component may be independently moveable. The image sensor may include a flexible connector that flexes to accommodate movement of the image sensor. The imaging device may further include an image processor, which may receive a first image generated while the image sensor is positioned in a first pose and a second image generated while the image sensor is positioned in a second pose. The image processor may combine the first image and the second image to generate a composite image that includes image information from more of the image circle provided by the optics system than either the first image or the second image. The optics system may include a polarization filter.

In another example, a method for capturing an extended portion of the image circle generated by a wide-angle lens may include receiving light through an optics system that produces an image circle that exceeds at least one dimension of an imaging area of an image sensor. The method may also include activating a positioning system coupled to the image sensor to move the image sensor to an altered pose that receives light from a different portion of the image circle and capturing an image while the image sensor is positioned in the altered pose.

In some implementations, the method may further include capturing another image while the image sensor is positioned in a default pose provided by the positioning system in the absence of activation energy. The method may further include combining a first image and a second image into a composite image. The method may further include processing the first image with an imaging processor to identify a target object in the image, determining a movement of the identified target object, and activating the positioning system to move the image sensor based on the movement of the identified target object. The identified target object in the image may be a face. Activating the positioning system coupled to the image sensor to move the image sensor to an altered pose may include activating a first positioning component to move a first subsensor in a first direction and activating a second positioning component to move a second subsensor in a second direction that is opposite to the first direction. An image may include an image portion with a first resolution and an image portion with a second resolution that is different than the first resolution. Implementations of the described techniques may include or involve hardware, a method or process, or computer software on a computer-accessible medium.

In another example, a system may include a housing and an imaging device, positioned within the housing, having an image sensor with an imaging area that receives light to generate an image from the received light. The system may also include a lens that produces an image circle on the image sensor, the image circle exceeding at least one dimension of the imaging area of the image sensor. The system may also include a positioning system coupled to the image sensor to move the image sensor with respect to the lens such that the image sensor captures a portion of the image circle that exceeds the at least one dimension of the imaging area.

In some implementations, the lens may include a fisheye lens. The imaging area may include an array of imaging subsensors. Each imaging subsensor of the array of imaging subsensors is coupled to an individual positioning component included in the positioning system.

In some examples, the above-described method may be encoded as computer-readable instructions on a computer-readable medium. For example, a computer-readable medium may include one or more computer-executable instructions that, when executed by at least one processor of a computing device, may cause the computing device to generate an image from light received by an image sensor through an optics system that produces an image circle that exceeds at least one dimension of an imaging area of the image sensor, to activate a positioning system coupled to the image sensor to move the image sensor to an altered pose that receives light from a different portion of the image circle, and to capture an image while the image sensor is positioned in the altered pose.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate several exemplary embodiments and are a part of the specification. Together with the following detailed description, these drawings demonstrate and explain various principles of the instant disclosure.

FIG. 1 is a block diagram of an imaging device in an imaging environment, according to some aspects of the present disclosure.

FIG. 2 presents exemplary views of imaging device configurations showing the image circles provided by optics systems relative to an image sensor included in the imaging device.

FIG. 3 is a cross-sectional diagram of the imaging device of FIG. 1, according to some aspects of the present disclosure.

FIG. 4 is a top view diagram of an image sensor, according to some aspects of the present disclosure.

FIGS. 5A, 5B, and 5C are cross-sectional drawings showing controlled movement of the image sensor of FIG. 4, according to some aspects of the present disclosure.

FIG. 6 is a top view diagram of another image sensor, according to some aspects of the present disclosure.

FIGS. 7A, 7B, 7C, and 7D are cross-sectional drawings showing controlled movement of the image sensor of FIG. 6, according to some aspects of the present disclosure.

FIG. 8 presents exemplary views of imaging device configurations showing the image circles provided by optics systems relative to a positionable image sensor included in the imaging device, according to some aspects of the present disclosure.

FIG. 9 is a flowchart of a method of capturing an extended portion of an image circle, according to some aspects of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to apparatuses, systems, and devices that permit an image sensor to capture more of the image circle produced by an optics system. To capture more information from the image circle, the image sensor may be moved, by panning and/or tilting. In some instances, the entire imaging area may be moved together, while in other instances the imaging area may be formed from an array of individual components or subsensors. The present disclosure is also generally directed to methods of utilizing such imaging devices. As will be explained in greater detail below, embodiments of the instant disclosure may be operated to track an object or a face by manipulating the image sensor, even when the imaging device that houses the image sensor remains in a fixed position. Computer-vision can be used to identify an object within an imaging area and a positioning system coupled to the image sensor can be controlled to move the image sensor to follow the identified object, allowing for computer-directed computer-vision.

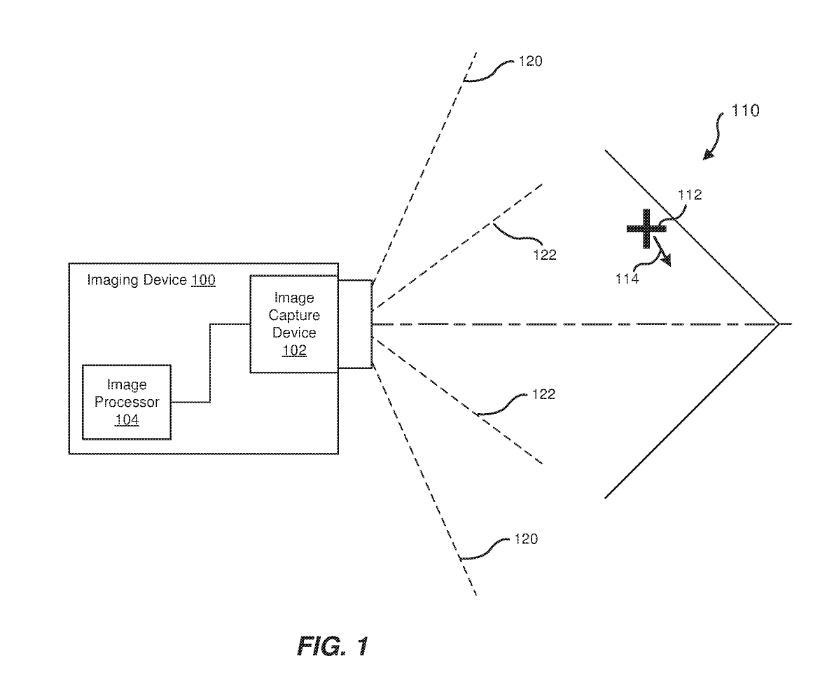

The following will provide, with reference to FIGS. 1-9, detailed descriptions of exemplary apparatuses, systems, and methods. The drawings demonstrate how embodiments of the present disclosure can increase the imageable portion of the image circle when the image circle exceeds at least one dimension of the image sensor being used to capture images.

FIG. 1 is a block diagram of an imaging device 100 in an imaging environment, according to some aspects of the present disclosure. As shown, the imaging device 100 is oriented to capture image information from an imaging environment, referred to as the local area 110. The imaging device 100 may be secured within the local area 110, in some embodiments. For example, the imaging device 100 may be a camera, such as a surveillance camera that is attached or secured to a wall, an overhang, a pole, etc., within the environment. In other implementations, the imaging device 100 may be a component of a smartphone that is used to capture images of a user and/or capture images of the local area 110 at the direction of the user. The imaging device 100 may be an image-capture camera, as used in photography, a depth-sensing camera, or any other suitable image-acquisition device. The imaging device 100 may also be a head-mounted display, in some embodiments, and may include a display in addition to other expressly depicted components.

The local area 110 may represent an area that is visible to the imaging device 100 and from which the imaging device 100 may capture image information. While the local area 110 may include many different objects (people, animals, structures, vehicles, plants, etc.) an exemplary object 112 is included for purposes of describing aspects of the present disclosure. As described in greater detail herein, the imaging device 100 may include an image capture device 102 that is configured to receive light from the local area 110 and produce corresponding digital signals that form or can be used to form images, such as still images and/or videos, of the local area 110 and the exemplary object 112. For example, the image capture device 102 may capture an image of the exemplary object 112 as it moves according to the arrow 114 within the local area 110.

Some embodiments of the imaging device 100 may include an image processor 104. The image processor 104, which may be integrated into the image capture device 102 in some embodiments and external in others, may receive digital signals from the image capture device 102, and may process the digital signals to form images or to alter aspects of generated images. Additionally, some embodiments of the image processor 104 may use artificial intelligence (AI) and computer-vision algorithms to identify aspects of the local area 110. For example, the image processor 104 may identify objects and/or features in the local area, such as one or more individuals or one or more faces.

Depending on certain characteristics of the image capture device 102, the image capture device 102 may be able to capture a greater or lesser portion of the local area 110 in front of and/or surrounding the image capture device 102. In other words, the image capture device 102 may have a different field of view depending on characteristics, such as the focal length, the aperture diameter, placement, etc. FIG. 1 depicts a larger field of view 120 and a smaller field of view 122, relative to each other. Such embodiments of the image capture device 102 may capture a correspondingly greater or lesser amount of the scene represented by the local area 110.

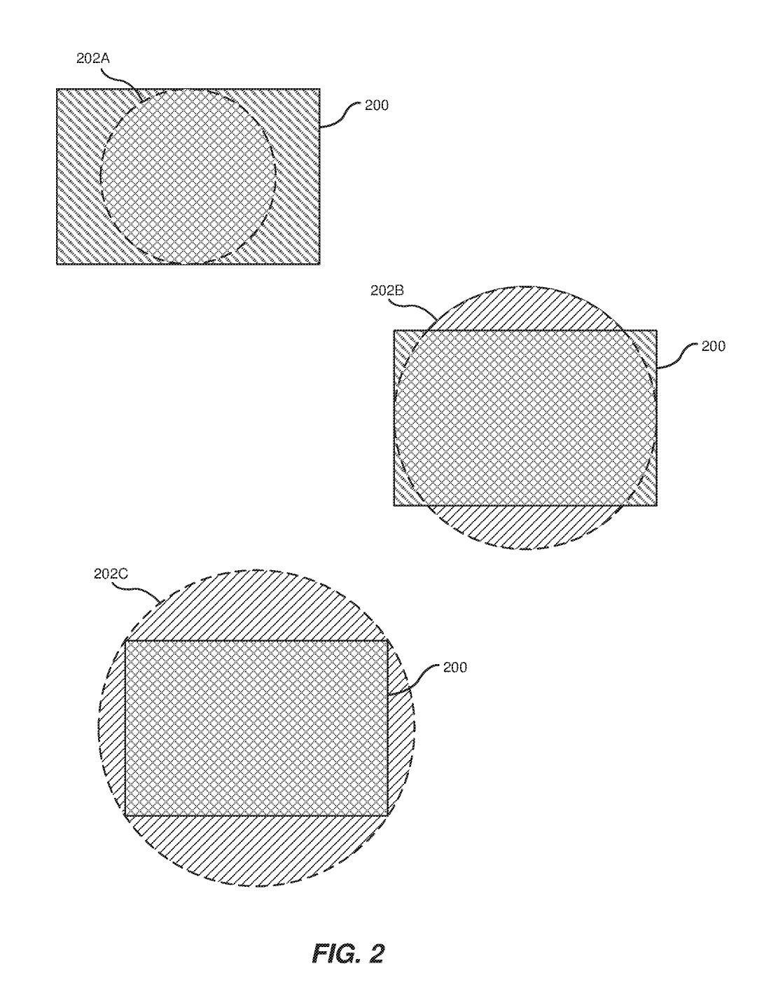

FIG. 2 presents exemplary views of image capture device configurations showing the image circles provided by the optics systems thereof relative to an image sensor area 200 provided by embodiments of the image capture device 102. In some instances, the image sensor area 200 may be defined by a two-dimensional resolution measured in terms of the number of pixels included in a sensor array formed on the surface of an image sensor or measured in terms of a physical area.

The optics system (i.e. lens, apertures, filters, and/or other structures and devices positioned between the local area 110 and the image sensor area 200) included in the image capture device 102 may produce an image circle on the surface of the image sensor. The portion of the image circle that is coincident with the image sensor area 200 may be captured by the image sensor, while the portion of the image circle that extends beyond the edges of the image sensor area 200 may not be captured by the image sensor. Depending on the configuration of the optics system included in the image capture device 102, the optics system may produce the image circle 202A on the image sensor, such that the entire image circle 202A fits within the image sensor area 200. As shown, the diameter of the image circle 202A may be approximately the same as the length of the minor axis of the image sensor area 200, which may be rectangular in shape, rather than square. In this example, the entire field of view included in the image circle 202A may be captured, while a substantial portion of the image sensor area 200 remains unused. The image circle 202B may have an outer diameter that is approximately the same as the length of the major axis of the image sensor area 200. While this configuration utilizes a greater portion of the image sensor area 200, there are still portions of the image circle 202B that may not be captured by the image sensor that provide the image sensor area 200. The image circle 202C may have a diameter that is approximately equal to the diagonal dimension of the image sensor area 200. Other embodiments may have an image circle 202C with a diameter that exceeds the diagonal dimension of the image sensor area 200. In such embodiments, the full area of the image sensor area 200 may be utilized to capture an image or images of the field of view. However, a significant portion of the image circle 202C may not be captured in images obtained using a conventional image sensor having the depicted image sensor area 200.

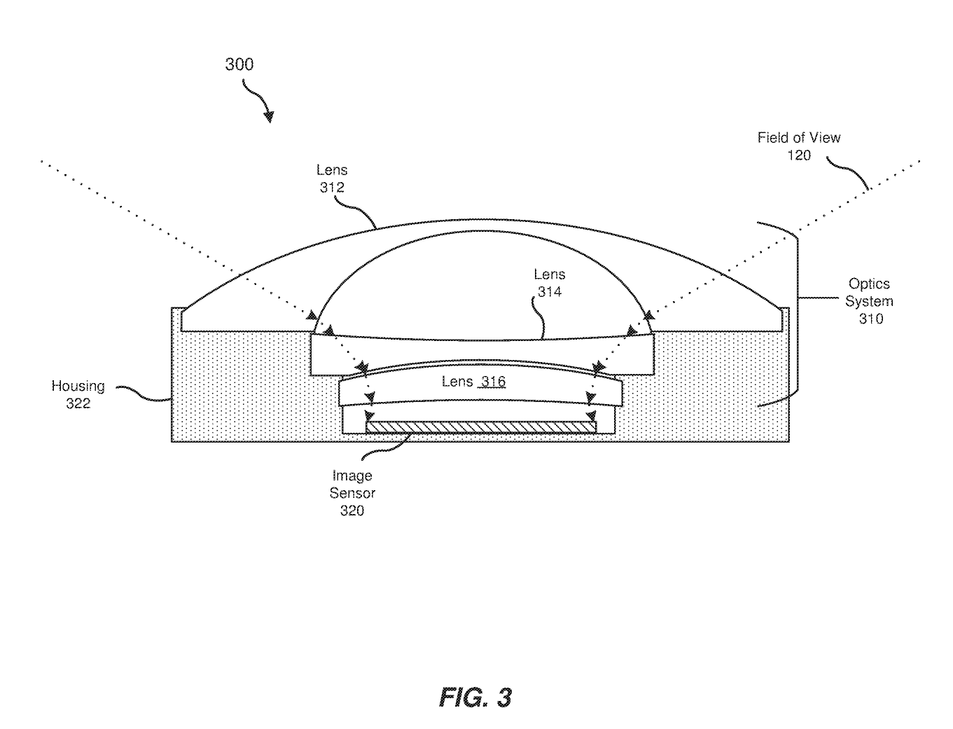

FIG. 3 is a cross-sectional diagram of an image capture device 300 that may provide an embodiment of the image capture device 102 of FIG. 1, according to some aspects of the present disclosure. As illustrated, the image capture device 300 includes an optics system 310 and an image sensor 320 coupled together by a sensor package or housing 322. The housing 322 may include electrical connections extending between the back of the image sensor 320 and the back side of the housing 322. Embodiments of the optics system 310 may include a plurality of lenses, apertures, filters, etc., that provide an optical pathway by which light from the local area 110 may reach the image sensor 320, which captures the light and encodes corresponding images.

As shown in FIG. 3, the optics system 310 may include several lenses, including the lenses 312, 314, and 316. These lenses may individually or collectively provide a “fisheye” lens or ultra-wide-angle lens, in some embodiments. The inclusion of a fisheye lens 312 in the optics system 310 may permit the image capture device 300 to capture wide panoramic or hemispherical images of the local area 110. In some embodiments, one or more of the lenses 312, 314, and 316 may be or may include a polarization filter to limit the polarization of light passing therethrough. The comparisons of image sensor area 200 to the image circles shown in FIG. 2 may be the result of configurations of image capture devices that utilize fisheye lenses. The optics system 310 may permit the image sensor 320 to capture images that correspond to the field of view 120 of FIG. 1.

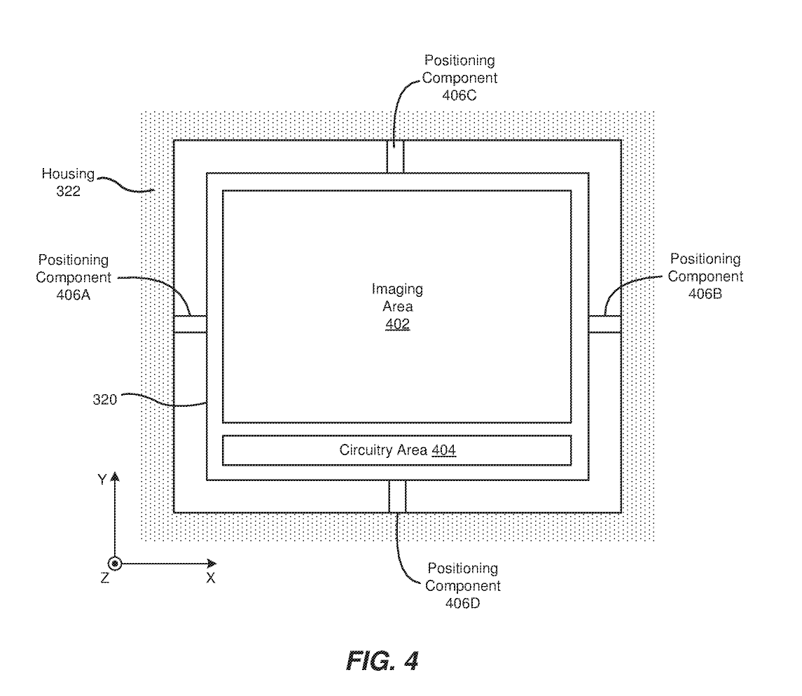

FIG. 4 is a top view diagram of an embodiment of the image sensor 320 of FIG. 3, according to some aspects of the present disclosure. FIG. 4 shows that the image sensor 320 includes an imaging area 402 and a circuitry area 404. The imaging area 402 may include an array of individual pixels extending in x- and y-directions that respond to incident light to generate an electrical responsive signal that can be interpreted to generate images. The pixels may be formed from photodiodes, photoresistors, or other photosensitive elements and may be CMOS devices, CCD devices, etc. The circuitry area 404 contains electronic circuitry that enables the reading or collection of images from the imaging area 402. The circuitry area 404 may further include image processing circuitry to apply functions such as auto-white balance, color correction, etc. In some embodiments, the circuitry area 404 may include control circuitry that actuates mechanisms to position the image sensor 320. Such mechanisms may include a positioning system having a plurality of individual positioning components. In FIG. 4, positioning components 406A, 406B, 406C, and 406D, collectively referred to as positioning components 406, are provided to enable positioning or posing of the image sensor 320.

As shown in FIG. 4, the positioning components 406 may secure the image sensor 320 to the housing 322 in some embodiments. The positioning components 406 may include one or more MEMS actuators, voice coil motors, or any other suitable actuation mechanism or mechanisms that can bend, expand, and/or contract to move the image sensor 320 and its imaging area 402 in x-, y-, and/or z-directions and/or to tilt the imaging area 402. By moving the imaging area 402 by raising/lowering, panning, and/or tilting, the amount of the image circle produced by an optics system and reproduced in an image or images can be increased. The position and orientation of the imaging area 402 may be referred to as the pose of the imaging area 402.

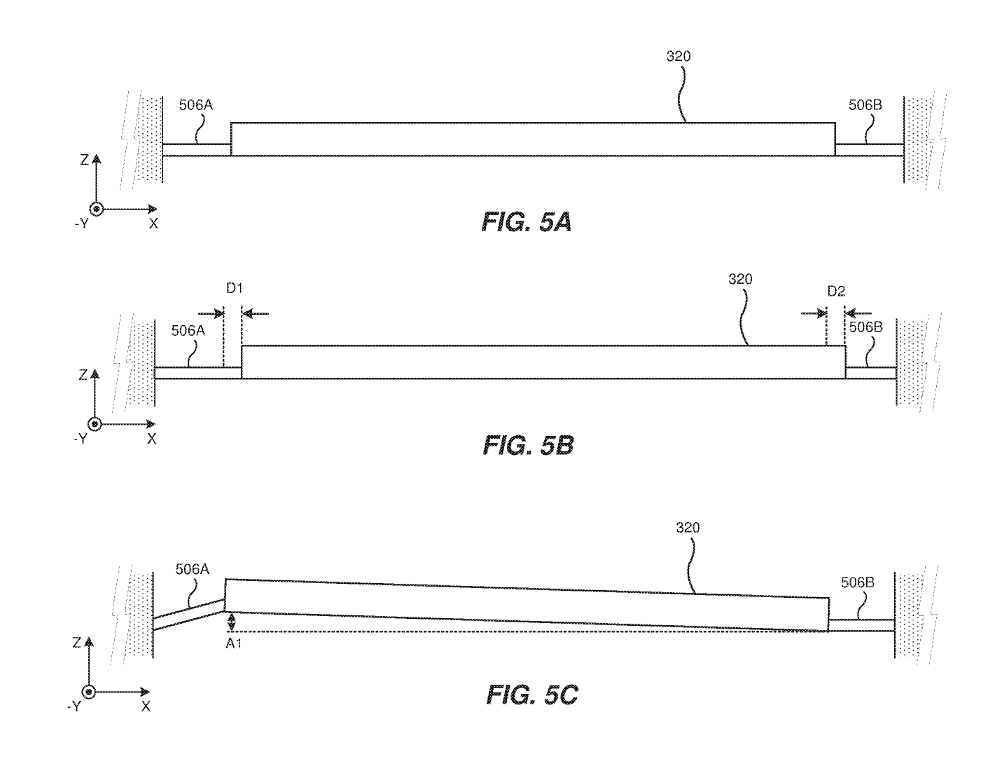

FIGS. 5A, 5B, and 5C are cross-sectional drawings showing controlled movement of the image sensor of FIGS. 3 and 4, according to some aspects of the present disclosure. FIG. 5A shows that the image sensor 320 is coupled to the housing 322 by positioning components 506A and 506B, which may be in an identical state of actuation. While the positioning components may be provided by many different actuation mechanisms, the positioning components shown in FIGS. 5A-C operate by expansion and/or contraction. The image sensor 320 may be coupled to additional electronics, such as the image processor 104 by a flexible connector that contacts the back surface of the image sensor 320 and includes a plurality of flexible leads. In FIG. 5B, the image sensor 320 is shifted or panned in the x-direction by an expansion of the positioning component 506A and a corresponding contraction of the positioning component 506B. As shown, the positioning component 506A expands by a length or distance D1. The distance D1 may be 10 microns, 50, microns, 100 microns, or more in some embodiments. The positioning component 506B may decrease in length by a distance D2 that is substantially the same as the distance D1, when the image sensor 320 is to be panned but not tilted.

As shown in FIG. 5C, the image sensor 320 may be tilted by expanding the positioning component 506A by a distance, like the distance D1, while producing a smaller contraction or no contraction in the opposite positioning component, positioning component 506B. The increase in the length of the positioning component 506A without the corresponding decrease in length of the positioning component 506B results in a z-direction change of the left side of the image sensor 320 as shown in FIG. 5C. This can be observed in FIG. 5C by the change in angle A1, which represents a tilt angle of the image sensor 320. In some embodiments, the positioning component 506B may be activated in the same way as the positioning component 506A to produce an overall movement of the image sensor 320 in the z-direction. Actuation of the positioning components 506A and 506B may cause individual pixels included in the image sensor 320 to be moved relative to an image circle provided by the optics system 310 of FIG. 3. This may enable the image sensor 320 to capture an increased portion of the image circle, effectively enhancing the field of view available to the image sensor 320.

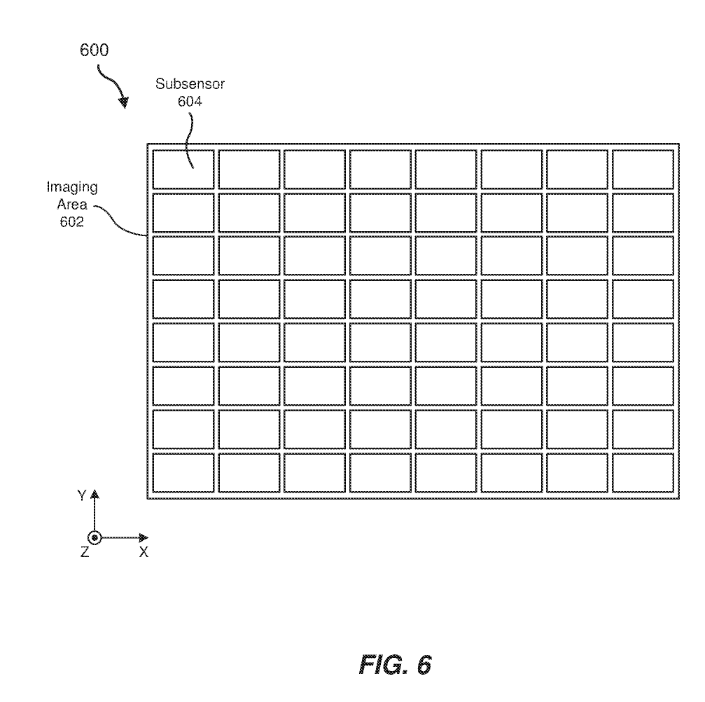

FIG. 6 is a top view diagram of an image sensor 600, according to some aspects of the present disclosure. The image sensor 600 includes an imaging area 602 that is comparable to the imaging area 402 of FIG. 4. The image sensor 600 includes an array of individually actuatable imaging subsensors 604. As shown, the subsensors 604 may have a generally rectangular shape, although other embodiments of the image sensor 600 include subsensors 604 having different shapes, such as square, triangular, etc. The subsensors 604 may each include an array of pixels extending across the surface of the subsensors 604. Embodiments of the image sensor 600 may include arrays of various sizes. For example, an embodiment of the image sensor 600 may include a 2×2 array of subsensors 604, while another embodiment of the image sensor 600 may include a 128×128 array of subsensors 604. Additional embodiments may have more or fewer subsensors 604 in the array.

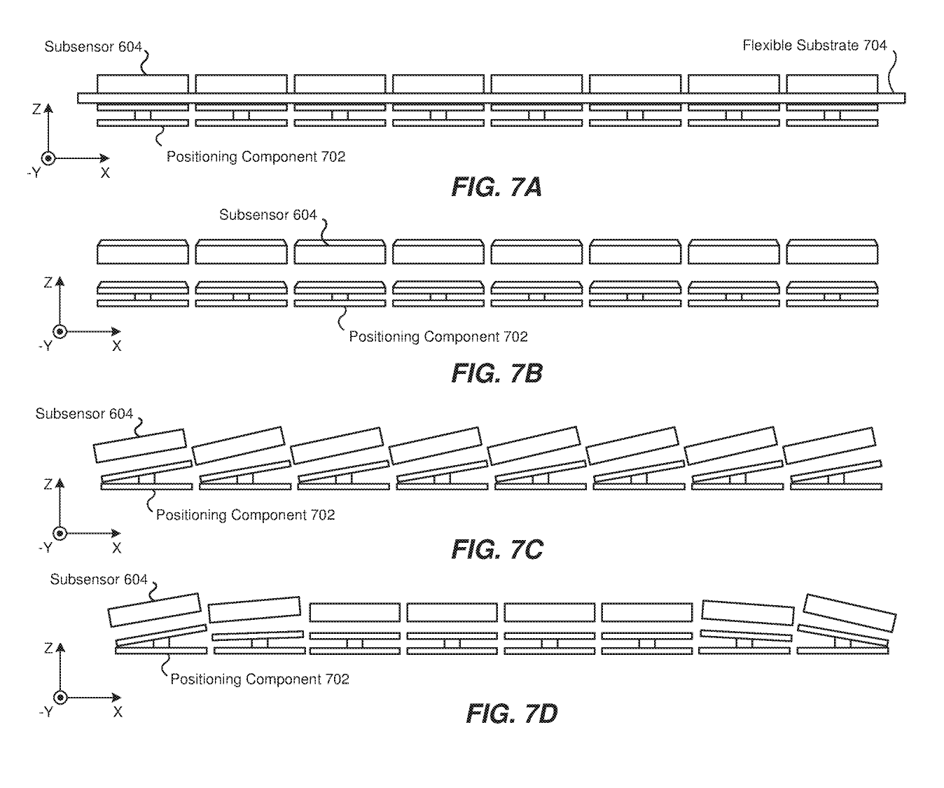

FIGS. 7A, 7B, 7C, and 7D are cross-sectional drawings showing controlled movement of the image sensor 600 of FIG. 6, according to some aspects of the present disclosure. FIG. 7A depicts the image sensor 600 in a resting or default state in which each of the subsensors 604 is positioned parallel to the xy-plane. FIG. 7A further depicts a plurality of positioning components, including an exemplary positioning component 702. The image sensor 600 may include one positioning component 702 for each subsensor 604, in some embodiments. Other embodiments may include different numbers of positioning components 702 and subsensors 604. The positioning components 702 may be provided by mechanical structures or MEMS structures that can bend each positioning component out of alignment with the z-axis. For example, the MEMS structures utilized in the manipulation of digital micromirror devices in digital light projection (DLP) technology may be used as positioning components. By bending, the positioning component 702 may reorient the corresponding subsensors 604.

The image sensor 600 may include flexible connectors that permit the individual subsensors 604 to remain in electrical communication with a controller or image processor to obtain image data to generate one or more images. As shown in FIG. 7A, the flexible connectors may be provided in a flexible substrate 704 disposed between the positioning components 702 and the corresponding subsensors 604. The flexible substrate 704 may be formed from a flexible material, such as silicone or polyimide, and may include electrical leads extending therethrough that provide for communication between the individual subsensors 604 and associated circuitry provided in a circuitry area, like the circuitry area 404 of FIG. 4, or in an external image processor, like the image processor 104 of FIG. 1. The flexible substrate 704 may provide for the collection of information from the subsensors 604 and the control of the subsensors 604 even when the positioning components 702 cause a change in the relative position of two or more proximate subsensors.

As shown in FIG. 7B, all of the positioning components 702 may be actuated to cause the subsensors 604 to tilt toward the −y-direction, and as shown in FIG. 7C, the positioning components 702 may be actuated to cause the subsensors 604 to tilt in the −x-direction. The positioning component 702 may be actuated individually to provide for individual positioning of the subsensors 604. As shown in FIG. 7D, some of the positioning component 702 may be actuated to change the positions of the corresponding subsensors 604, while others of the positioning components 702 may remain in a default position. FIG. 7D shows that the subsensors 604 located on the outer edge of the array may be tilted outwardly, while the central subsensors 604 have no tilt. In other embodiments, the positioning component 702 may be actuated to cause the subsensor 604 located on the outer edge of the array to be tilted inwardly or to cause one side of the array to be tilted inwardly while subsensors on the other side of the array are tilted outwardly.

When actuators, like the positioning components 406 of FIG. 4, 506 of FIG. 5, and 702 of FIG. 7, are activated to change the position of an entire imaging area or of portions thereof, the control signals may be recorded in memory included in the circuitry area 404 or elsewhere in other embodiments. An image processor, like the image processor 104 of FIG. 1, may utilize the actuation information and the received image information from each of the pixels to generate an image having different areas of resolution. For example, image data obtained from the subsensors 604 on the outer edge of the imaging area shown in FIG. 7D may have a lower resolution than the image data obtained from subsensors 604 of the central area. In other embodiments, the subsensors 604 of the central area may be tilted toward each other to produce a higher resolution portion of an image.

Information included in an image may be used to direct the positioning of subsensors 604. For example, the image processor 104 may identify the object 112 in the local area 110 and generate control signals that cause the positioning components of an imaging device to actuate in response to the object 112. In some embodiments, the positioning components, such as the positioning components 702, may be actuated to tilt some or all of the subsensors 604 toward the portion of the imaging array that is receiving the light corresponding to the object 112.

In some instances, the image processor 104 may cause the image sensor 320 or 600 to provide a higher resolution image relative to the object 112, which may be a face, a tool, a symbol of interest, etc., by directing that the positioning components 702 orient subsensors 604 toward the object 112. In other instances, the image processor may cause some of the positioning components 702 to move so as to follow the object 112 as it moves according to the arrow 114, also of FIG. 1.

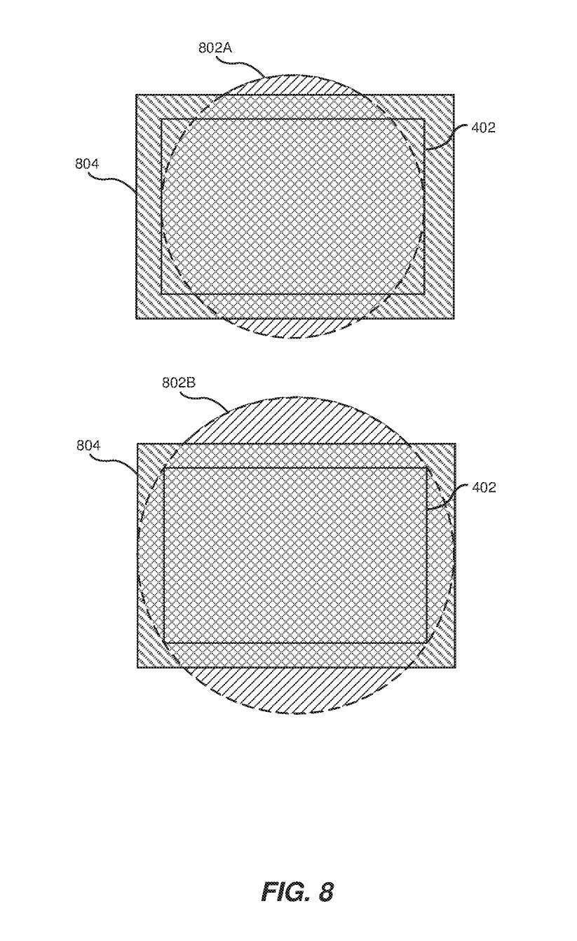

FIG. 8 presents exemplary views of imaging device configurations showing the image circles provided by optics systems relative to an image sensor area associated with the imaging device, according to some aspects of the present disclosure. The actual x- and y-dimensions of the imaging area 402 are represented. The image circle 802A has an outer diameter approximately equal to the major axis of the imaging area 402. By actuating positioning components 702, the effective x- and y-dimensions of an image sensor can be extended beyond the actual dimensions, as represented by the effective imaging area 804, which may capture significantly more of the information provided by the image circle 802A.

Similarly, the image circle 802B may have an outer diameter approximately equal to the diagonal of the imaging area 402, such that the imaging area 402 captures a smaller portion of the information included in the image circle 802B than of the image circle 802A. By selective actuation of included positioning components, information from the effective imaging area 804 may be captured, which may be significantly greater than the actual dimensions of the imaging area 402.

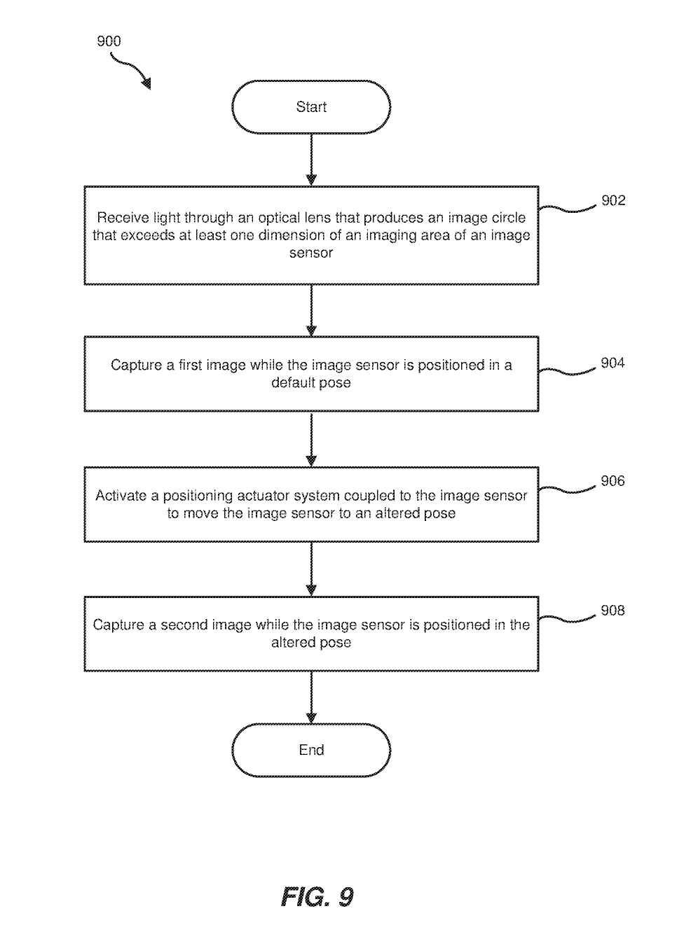

FIG. 9 is a flow diagram of an exemplary computer-implemented method 900 for capturing an extended portion of an image circle. The steps shown in FIG. 9 may be performed by any suitable computer-executable code and/or computing system in connection with an imaging system, including the system(s) illustrated in FIGS. 1 and 3-8. In one example, one or more of the steps shown in FIG. 9 may represent an algorithm whose structure includes and/or is represented by multiple sub-steps, examples of which will be provided in greater detail below.

As illustrated in FIG. 9, at step 902 one or more of the systems described herein may receive light through an optics system that produces an image circle that exceeds at least one dimension of an imaging area of an image sensor. For example, light may be received by an imaging area 402 (FIG. 4) of an image sensor 320 through the optics system 310 of FIG. 3. The optics system 310 may be a fisheye lens system or include a fisheye lens.

At step 904, one or more of the systems described herein may capture a first image while the image sensor is positioned in a default pose. For example, the image sensor 320 may be in a default position as shown in FIG. 7A, in which a positioning system is not activated.

At step 906, one or more of the systems described herein may activate a positioning system coupled to the image sensor to move the image sensor to an altered pose that receives light from a different portion of the image circle than is received by the image sensor in a default pose. For example, the positioning components 406, 506, or 702 of a positioning system may pan, tilt, raise, or lower the image sensor 320, as shown in FIGS. 5A-C and/or FIGS. 7A-D.

At step 908, one or more of the described systems may capture a second image while the image sensor is positioned in the altered pose. The circuitry in the circuitry area 404 or another controller may trigger the capture of the first and second images. After the first and second images have been captured, the image processor 104 or another component described herein may combine the images to produce a composite image. Such a composite image may have a larger resolution, measured in pixels, than either the first image or the second image. This composite image may capture a larger portion of an image circle than a single image captured in the default pose, as shown in FIG. 8.

Some embodiments of the method 900 may further include steps of processing the first image with an imaging processor to identify a target object in the image, determining a movement of the identified target object, and activating the positioning system to move the image sensor based on the movement of the identified target object. In this way, the method 900 may provide for tracking of the object 112 in the local area 110 as the object moves around.

In some embodiments, the step of activating a positioning system coupled to the image sensor to move the image sensor to an altered pose may further include activating a first positioning component to move a first subsensor in a first direction and activating a second positioning component to move a second subsensor in a second direction that is opposite to the first direction, as shown in FIG. 7D. The first subsensor and the second subsensor may be moved toward each other or away from each other. The first and second subsensors may be disposed proximate each other in an array of subsensors or may be disposed on opposite sides of the array. In some embodiments, the actuation of positioning components may produce an image that has a portion with a first resolution and a portion with a second resolution that is different than the first resolution.

As detailed above, the processing and computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data in the form of one or more images to be transformed, transform the image data, output a result of the transformation to generate composite images or images having multiple resolutions, use the result of the transformation to enhancement of the field of view of an image sensor, and store the result of the transformation to so that the enhanced images can be used by an image processor or other system. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. An imaging device, comprising:
an image sensor having an imaging area that receives light to generate an image from the received light;
an optics system that produces an image circle over the image sensor, the image circle exceeding at least one dimension of the imaging area of the image sensor; and
a positioning system coupled to the image sensor to pan or tilt the image sensor with respect to the optics system such that the image sensor captures a portion of the image circle that exceeds the at least one dimension of the imaging area.

2. The imaging device of claim 1, wherein the optics system comprises a fisheye lens.

3. The imaging device of claim 1, wherein the imaging area comprises an array of imaging subsensors.

4. The imaging device of claim 3, wherein each imaging subsensor of the array of imaging subsensors is coupled to an individual positioning component included in the positioning system.

5. The imaging device of claim 4, wherein each individual positioning component is independently moveable.

6. The imaging device of claim 1, wherein the image sensor comprises a flexible connector that flexes to accommodate movement of the image sensor.

7. The imaging device of claim 1, further comprising an image processor, wherein the image processor receives a first image generated while the image sensor is positioned in a first pose and a second image generated while the image sensor is positioned in a second pose.

8. The imaging device of claim 7, wherein the image processor combines the first image and the second image to generate a composite image, wherein the composite image encompasses more of the image circle provided by the optics system than either the first image or the second image.

9. The imaging device of claim 1, wherein the optics system comprises a polarization filter.

10. A method comprising:
receiving light through an optics system that produces an image circle that exceeds at least one dimension of an imaging area of an image sensor;
activating a positioning system coupled to the image sensor to move the image sensor to an altered pose that receives light from a different portion of the image circle; and
capturing a first image while the image sensor is positioned in the altered pose.

11. The method of claim 10, further comprising capturing a second image while the image sensor is positioned in a default pose, wherein the default pose is the pose provided by the positioning system in the absence of activation energy.

12. The method of claim 11, further comprising combining the first image and the second image into a composite image.

13. The method of claim 10, further comprising:
processing the first image with an imaging processor to identify a target object in the image;
determining a movement of the identified target object; and
activating the positioning system to move the image sensor based on the movement of the identified target object.

14. The method of claim 13, wherein the identified target object in the image is a face.

15. The method of claim 10, wherein activating a positioning system coupled to the image sensor to move the image sensor to an altered pose comprises:
activating a first positioning component to move a first subsensor in a first direction; and
activating a second positioning component to move a second subsensor in a second direction that is opposite to the first direction.

16. The method of claim 15, wherein the captured first image comprises an image portion with a first resolution and an image portion with a second resolution that is different than the first resolution.

17. A system comprising:
a housing; and
an imaging device, disposed within the housing, that comprises:
an image sensor having an imaging area that receives light to generate an image from the received light;
a lens that produces an image circle over the image sensor, the image circle exceeding at least one dimension of the imaging area of the image sensor; and
a positioning system coupled to the image sensor to pan or tilt the image sensor with respect to the lens such that the image sensor captures a portion of the image circle that exceeds the at least one dimension of the imaging area.

18. The system of claim 17, wherein the lens comprises a fisheye lens.

19. The system of claim 17, wherein the imaging area comprises an array of imaging subsensors.

20. The system of claim 19, wherein each imaging subsensor of the array of imaging subsensors is coupled to an individual positioning component included in the positioning system.
